(19) United States
(12) Patent Application Publication
(10) Pub. No.: US 2026/0352957 A1
(43) Pub. Date: Nov. 5, 2026

(54) ILLUMINANCE ESTIMATION METHOD, ILLUMINATION CONTROL METHOD, NON-TRANSITORY COMPUTER READABLE MEDIUM, CONTROL DEVICE, AND ILLUMINATION CONTROL SYSTEM

(71) Applicant: KYOCERA Corporation, Kyoto-shi, Kyoto (JP)

(72) Inventors: Jun KANO, Yokohama-shi, Kanagawa (JP); Hironori FUNAKOSHI, Yokohama-shi, Kanagawa (JP); Tsubasa IMAMURA, Yokohama-shi, Kanagawa (JP); Masatoshi YANASE, Yokosuka-shi, Kanagawa (JP)

(21) Appl. No.: 19/105,037

(22) PCT Filed: Aug. 3, 2023
(86) PCT No.: PCT/JP2023/028468

§ 371 Date: Feb. 20, 2025

(30) Foreign Application Priority Data
Aug. 23, 2022 (JP) 2022-132791

(51) Int. Cl. H04N 23/71; H04N 9/77; H04N 23/56; H04N 23/74

(52) U.S. Cl. CPC H04N 23/71; H04N 9/77; H04N 23/56; H04N 23/74

(57) ABSTRACT

An illuminance estimation method includes: acquiring a captured image of a range including a prescribed position captured by an image-capturing device; and when the lightness or brightness of the captured image corresponds to the illuminance of the prescribed position, estimating an illuminance of the prescribed position based on the lightness or brightness of the captured image.

### CROSS-REFERENCE TO RELATED APPLICATIONS

This application is a National Phase of International Application Number PCT/JP 2023/028468 filed Aug. 3, 2023, and claims priority of Japanese Patent Application No. 2022-132791 (filed August 23, 2022), the entire disclosure of which is hereby incorporated by reference.

### TECHNICAL FIELD

The present disclosure relates to an illuminance estimation method, an illumination control method, a non-transitory computer readable medium, a control device, and an illumination control system.

### BACKGROUND OF INVENTION

A known system controls illumination by estimating an illuminance distribution based on an image captured by a camera (for example, see Patent Literature 1).

### CITATION LIST

### Patent Literature

Patent Literature 1: Japanese Unexamined Patent Application Publication No. 9-312198

### SUMMARY

In an embodiment of the present disclosure, an illuminance estimation method includes: acquiring a captured image of a range including a prescribed position captured by an image-capturing device; and when a lightness or brightness of the captured image corresponds to an illuminance of the prescribed position, estimating the illuminance of the prescribed position based on the lightness or brightness of the captured image.

In an embodiment of the present disclosure, an illumination control method may include: controlling an illumination device configured to illuminate a range including the prescribed position based on estimation of the illuminance of the prescribed position obtained by performing the above illuminance estimation method.

In an embodiment of the present disclosure, a non-transitory computer readable medium stores an illuminance estimation program The illuminance estimation program is configured to cause a processor to: acquire a captured image of a range including a prescribed position captured by an image-capturing device; and when a lightness or brightness of the captured image corresponds to an illuminance of the prescribed position, estimate the illuminance of the prescribed position based on the lightness or brightness of the captured image.

In an embodiment of the present disclosure, a control device includes a controller. The controller is configured to estimate an illuminance of a prescribed position. The controller is configured to acquire a captured image of a range including a prescribed position captured by an image-capturing device, and when a lightness or brightness of the captured image corresponds to an illuminance of the prescribed position, estimate the illuminance of the prescribed position based on the lightness or brightness of the captured image.

In an embodiment of the present disclosure, an illumination control system includes a control device, an illumination device, and an image-capturing device. The illumination device is configured to illuminate a range including a prescribed position. The image-capturing device is configured to capture an image of the range including the prescribed position. The control device is configured to acquire a captured image of a range including the prescribed position captured by the image-capturing device, and when a lightness or brightness of the captured image corresponds to an illuminance of the prescribed position, estimate the illuminance of the prescribed position based on the lightness or brightness of the captured image.

### BRIEF DESCRIPTION OF THE DRAWINGS

FIG. 1 is a block diagram illustrating an example configuration of an illumination control system according to an embodiment.

FIG. 2 is a schematic diagram illustrating an example configuration of an illumination control area.

FIG. 3 is a schematic diagram illustrating an example of the relationship between light incident on a desk and light reflected by the desk and traveling to an image-capturing device.

FIG. 4 is a schematic diagram illustrating an example of light being reflected separately as directly reflected light and diffusely reflected light.

FIG. 5 is a diagram illustrating an example of a captured image.

FIG. 6 is an enlarged view of a dashed-line enclosed part A in FIG. 5.

FIG. 7 is an enlarged view of a dashed-line enclosed part B in FIG. 5.

FIG. 8 is a graph illustrating an example in which a difference in color tone between grids is represented as a chromatic distance.

FIG. 9 is a schematic diagram illustrating an example configuration of an illumination control area in which a first image-capturing device and a second image-capturing device are installed.

FIG. 10 is a diagram illustrating an example of a first captured image.

FIG. 11 is a diagram illustrating an example of a second captured image.

FIG. 12 is a flowchart illustrating example procedures of an illuminance estimation method and an illumination control method according to an embodiment.

FIG. 13 is a graph illustrating an example of the relationship between estimated values and measured values of illuminance.

### DESCRIPTION OF EMBODIMENTS

### Example Configuration of Illumination Control System 1

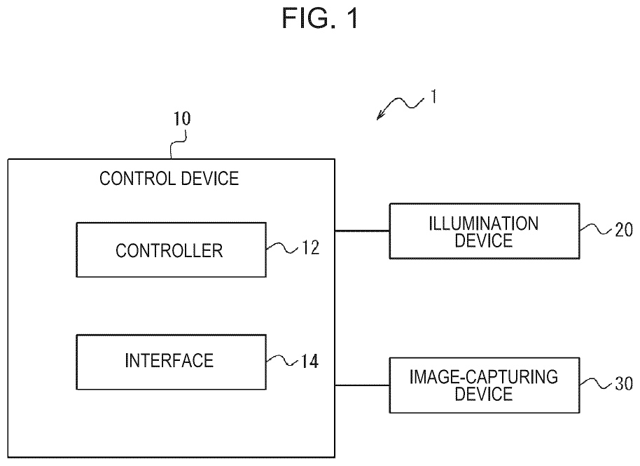

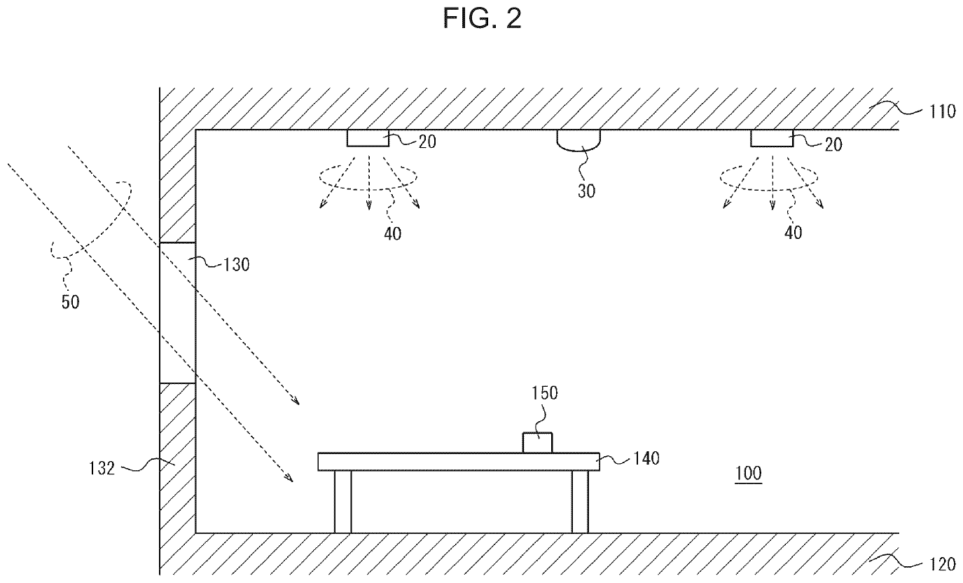

As illustrated in FIG. 1, in an embodiment, an illumination control system 1 includes a control device 10, illumination devices 20, and an image-capturing device 30. The illumination control system 1 controls illumination in an illumination control area 100 illustrated in FIG. 2. Examples of the illumination control area 100 may include various spaces for which illumination is to be controlled such as offices, conference rooms, or classrooms. The illumination control area 100 is a space enclosed by a ceiling 110, a floor 120, a window 130, and a wall 132. In the illumination control area 100, a desk 140 is placed on the floor 120. In this embodiment, the illumination devices 20 and the image-capturing device 30 are installed on the ceiling 110 of the illumination control area 100.

In the illumination control system 1, the control device 10 estimates the illuminance of the illumination control area 100 based on an image of the illumination control area 100 captured by the image-capturing device 30. The control device 10 controls the illumination devices 20 and controls the illuminance of the illumination control area 100 based on estimation results of the illuminance of the illumination control area 100.

Hereafter, an example configuration of each part of the illumination control system 1 is described.

### Control Device 10

The control device 10 includes a controller 12 and an interface 14. The controller 12 is configured to be able to control the illumination devices 20. The controller 12 may be configured to be able to control the image-capturing device 30. The controller 12 may include one or more processors. The processor can execute programs for realizing the various functions of the control device 10. The processors may be implemented as a single integrated circuit. An integrated circuit is also referred to as an IC. Processors may be implemented as multiple integrated circuits and discrete circuits connected so as to be able to communicate with each other. The processors may be realized based on various other known technologies.

The control device 10 may further include a storage unit. The storage unit may, for example, include an electromagnetic storage medium such as a magnetic disk, or may include a memory such as a semiconductor memory or a magnetic memory. The storage unit may store, for example, various information referred to during the operation of the control device 10 and programs for implementing the various functions of the control device 10. The storage unit may function as a working memory of the controller 12. The storage unit may be configured to be integrated with the controller 12, or may be configured to be separate from the controller 12.

The interface 14 may include a communication module that communicates with an external device such as the illumination devices 20 or the image-capturing device 30. The communication module may support mobile communication standards such as 4G (fourth Generation) or 5G (fifth Generation), for example. The communication module may support communication standards such as LAN (local area network). The communication module may support wired or wireless communication standards. The communication module may support various communication standards, including but not limited to the above examples. The interface 14 may be configured to be able to connect to an external communication module.

The interface 14 may include an input device that accepts inputs such as information or data from the user. The input device may include, for example, a touch panel or touch sensor or a pointing device such as a mouse. The input device may include physical keys. The input device may include an audio input device such as a microphone. The interface 14 may be configured to be connectable to an external input device.

The interface 14 may include an output device that outputs information, data, or the like to the user. The output device may include, for example, a display device that outputs visual information such as images or text or graphics. The display device may include, for example, an LCD (liquid crystal display), an organic EL (electro-luminescence) or inorganic EL display, or a PDP (plasma display panel). The display device is not limited to these displays and may include a display using any of a variety of other systems. The display device may include a light-emitting device such as an LED (light emitting diode) or an LD (laser diode). The display device may include various other devices. The output device may include an audio output device such as a speaker that outputs auditory information such as a voice. The output device may include a vibration device such as a vibrator that outputs tactile information such as vibrations, for example. The output device is not limited to these examples and may include a variety of other devices. The interface 14 may be configured to be connectable to an external output device.

### Illumination Device 20

Each illumination device 20 radiates illumination light 40. Examples of the illumination device 20 include various light sources, such as LEDs (light emitting diodes), semiconductor laser devices such as laser diodes, VCSELs (vertical cavity surface emitting lasers) or SLDs (super luminescent diodes). In this embodiment, the illumination device 20 is assumed to be configured as a glare-free downlight. A glare-free downlight is a light in which a light source structure or light reflecting mechanism is designed to reduce the glare of the radiated light in order to reduce unpleasant glare. A method used to evaluate unpleasant glare is described, for example, in JISZ9110: Shomei kijun sosoku (2010) or ISO8995: The lighting of indoor work systems (1989). The illumination device 20 may be configured in various other ways, not limited to a glare-free downlight.

The number of illumination devices 20 installed in the illumination control area 100 is not limited to two as illustrated in FIG. 2, and may be one, three, or more. When multiple illumination devices 20 are installed in the illumination control area 100, the illumination devices 20 may be configured so that the illumination devices 20 can be individually controlled to be turned on or off. The intensity of the illumination light 40 emitted by each illumination devices 20 may be individually controllable.

### Image-Capturing Device 30

The image-capturing device 30 captures an image of the illumination control area 100 and outputs the captured image to the control device 10. The image-capturing device 30 includes an image sensor that captures images electronically and is configured as a network camera, for example. The image-capturing device 30 may include a CCD (charge coupled device image sensor) or a CMOS (complementary metal oxide semiconductor) sensor as an image sensor.

The image-capturing device 30 may include, for example, a fisheye lens, and may capture images through a range up to 360 degrees around a plane perpendicular to an optical axis direction of the fisheye lens. The image-capturing device 30 may be configured to capture a conical range with a vertical direction serving as an axis when installed on the ceiling 110 of the illumination control area 100. The captured image formed by the fisheye lens is a circular image that is more heavily distorted with increasing distance from the optical axis. The image-capturing device 30 may output the circular image as is, or may output an image that has been corrected to bring the image closer to the actual appearance of the captured object.

### Example Operation of Illumination Control System 1

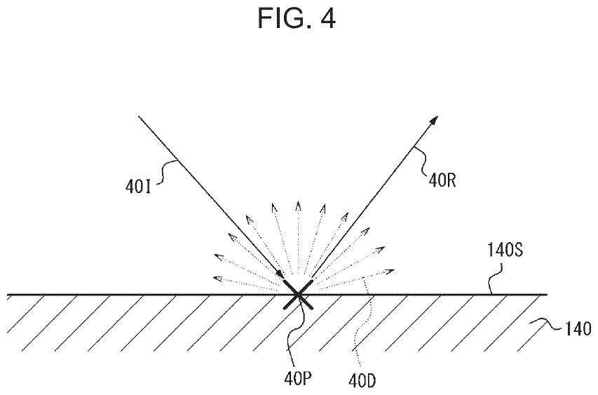

The illumination control system 1 controls the illuminance of the illumination control area 100. The illumination control area 100 is illuminated by the illumination light 40 emitted from the illumination devices 20 and outside light 50 entering through the window 130. In this case, the illuminance in each part of the illumination control area 100 is determined based on the intensity of the illumination light 40 reaching that part and the intensity of the outside light 50. The light reaching each part of the illumination control area 100 can include direct or indirect light. Direct light corresponds to the illumination light 40 or the outside light 50 arriving directly from the light source. Indirect light corresponds to light that arrives indirectly after the illumination light 40 or the outside light 50 has been reflected or scattered by other areas. In this embodiment, the intensity of indirect light is considered to be negligibly small compared to the intensity of direct light. Hereafter, an example of an operation for estimating illuminance based on an image captured by the image-capturing device 30 (see FIG. 4) will be described under the assumption that the illuminance of each part of the illumination control area 100 is determined by the intensity of the direct light of the illumination light 40 or the outside light 50.

### Correlation between Brightness of Captured Image and Illuminance in Captured Region

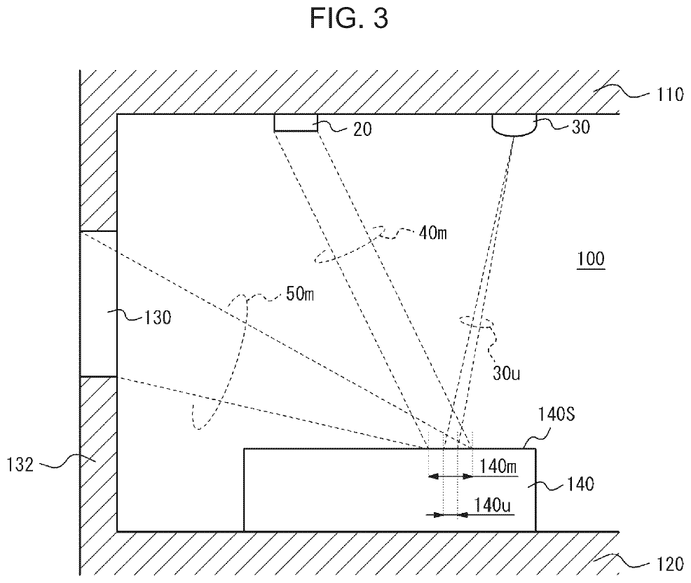

As illustrated in FIG. 3, light reaching a small region 140m of a top surface 140S of the desk 140 includes a partial component 40m of the illumination light 40 incident on the small region 140m from the illumination device 20 and a partial component 50m of the outside light 50 incident on the small region 140m from the window 130. Therefore, the illuminance in the small region 140m is determined based on the sum of the intensity of the partial component 40m of the illumination light 40 and the intensity of the partial component 50m of the outside light 50.

Here, the light incident on the small region 140m is assumed to be reflected according to the model of Lambert reflection. Lambert reflection is ideal diffuse reflection, also called perfect diffuse reflection. In the model of Lambert reflection, light incident on a flat surface is reflected in all directions. In the model of Lambert reflection, the intensity of light reflected in each direction from a flat surface is determined according to Lambert's cosine law in accordance with the angle between the normal to the plane and each direction. In other words, the intensity of light reflected in each direction from the flat surface is determined so that the brightness of the small region 140m is constant when viewed in any direction from the flat surface. This is because, for example, when the small region 140m is viewed from an inclined direction having an angle 0 with respect to the normal of the flat surface, the intensity of the reflected light traveling in the inclined direction is cos0 times the intensity of the reflected light traveling in the normal direction of the flat surface. On the other hand, the area of the small region 140m viewed from the inclined direction is reduced to cos0 times the area of the small region 140m viewed from the normal direction. The brightness is calculated as the intensity of light per unit area. Therefore, assuming that reflection follows the model of Lambert reflection, the brightness of the small region 140m is constant when viewed from any direction relative to the flat surface.

A portion of the light reflected in the small region 140m travels toward the image-capturing device 30. In other words, the small region 140m is regarded as a surface light source when viewed from the image-capturing device 30. When the image-capturing device 30 captures an image of the small region 140m, one pixel in the image captured by the image-capturing device 30 corresponds to a partial region 140u included in the small region 140m. The light traveling from the partial region 140u toward the image-capturing device 30 is represented as image-capturing light 30u. The brightness of the pixel corresponding to the partial region 140u corresponds to the intensity of the image-capturing light 30u. Here, assuming that light incident on the small region 140m is reflected in accordance with the model of Lambert reflection, the brightness of the small region 140m is constant when viewed from any direction. In other words, the brightness of the small region 140m corresponds to the illuminance in the small region 140m when viewed from any direction. Therefore, in the image captured by the image-capturing device 30, the brightness of the pixel corresponding to the partial region 140u, which is included in the small region 140m, corresponds to the illuminance in the small region 140m.

As discussed above, assuming that light incident on the small region 140m is reflected in accordance with the model of Lambert reflection, the brightness of the pixel corresponding to the small region 140m in the image captured by the image-capturing device 30 corresponds to the illuminance of the small region 140m. Therefore, the controller 12 of the control device 10 can estimate the illuminance of the part corresponding to each pixel in the illumination control area 100 based on the brightness of the corresponding pixel in the image captured by the image-capturing device 30.

The intensity of the image-capturing light 30u traveling from the partial region 140u toward the image-capturing device 30 can be correlated with the illuminance in the small region 140m, even when the light incident on the small region 140m is not reflected according to the model of Lambert reflection. The controller 12 may acquire information identifying the correlation between the intensity of the image-capturing light 30u from the partial region 140u set at a prescribed position in the illumination control area 100 and the illuminance in the small region 140m that includes the partial region 140u.

For example, if the small region 140m is set as part of the top surface 140S of the desk 140, the controller 12 may identify the correlation between the illuminance of the top surface 140S and the intensity of the image-capturing light 30u based on characteristics such as the material, surface shape, or reflectance of the top surface 140S. The controller 12 may estimate the illuminance of the small region 140m based on the brightness of a captured image of the top surface 140S.

For example, if the small region 140m is set as a portion of the floor 120, the controller 12 may identify the correlation between the illuminance of the floor 120 and the intensity of the image-capturing light 30u based on characteristics such as the material, surface shape, or reflectance of the floor 120. The controller 12 may estimate the illuminance of the floor 120 based on the brightness of the captured image of a floor 120.

### Effects of Direct Reflection

Here, as illustrated in FIG. 4, for example, when incident light 40I is incident on a point 40P on the top surface 140S of the desk 140, part of the incident light 40I can undergo regular reflection (specular reflection) at the point 40P. The light that underwent regular reflection at the point 40P is represented by a solid-line arrow as directly reflected light 40R and travels in a direction of regular reflection. The direction of regular reflection is a direction with linear symmetry with respect to the direction of the incident light 40I with the normal of the top surface 140S serving as the axis of symmetry.

On the other hand, another part of the incident light 40I can undergo diffuse reflection at the point 40P. The light diffusely reflected at the point 40P is represented by dashed-line arrows as diffusely reflected light 40D and can travel in various directions. The intensity of light traveling in each direction of the diffusely reflected light 40D can be determined according to the model of Lambert reflection.

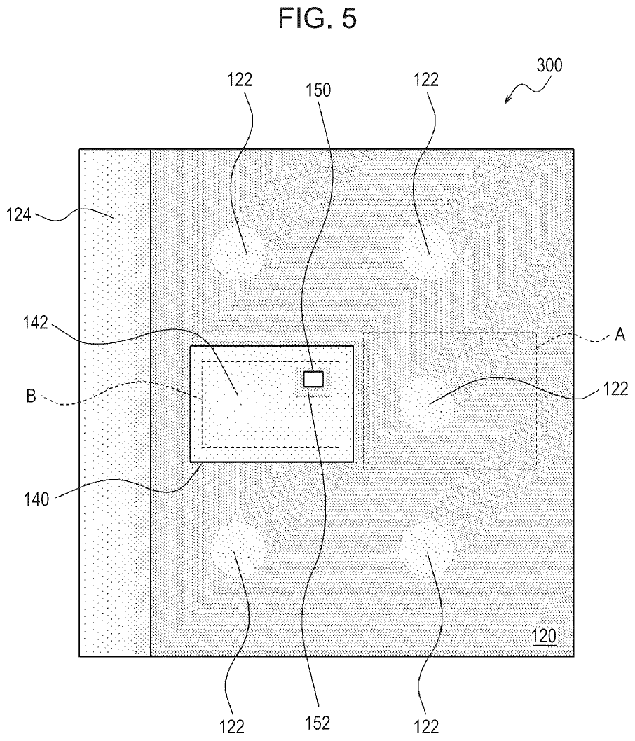

When the image-capturing device 30 is positioned in the direction of travel of the directly reflected light 40R, the directly reflected light 40R will appear at the pixel where the point 40P is captured in the image of the illumination control area 100 captured by the image-capturing device 30. For example, in an example of a target image 300 captured by capturing a portion of the illumination control area 100 as an image-capturing target illustrated in FIG. 5, light that is reflected by the floor 120, out of the illumination light 40 incident on the floor 120 from the illumination devices 20, appears as bright regions 122. The light that is directly reflected by the desk 140, out of the illumination light 40 incident on the desk 140 from the illumination devices 20, appears as a bright region 142. The light directly reflected by the floor 120, out of the outside light 50 incident on the floor 120 from the window 130, appears as a bright region 124.

If the illuminance is estimated based on the brightness of the bright region 122, 124, or 142, etc., where the directly reflected light appears, the estimation result of the illuminance could be higher than the actual illuminance. In other words, the estimation accuracy of illuminance may be reduced due to the appearance of the directly reflected light.

### Effect of Obstruction 150

In the illumination control area 100 illustrated in FIG. 2, an obstruction 150 is positioned on the top surface 140S of the desk 140. The obstruction 150 blocks or scatters in other directions the illumination light 40 or the outside light 50 traveling toward the top surface 140S of the desk 140. As a result, the light incident on the region around the obstruction 150 may be weakened. For example, in the target image 300 illustrated in FIG. 5, the region around the obstruction 150 on the desk 140 appears as a dark region 152.

If the illuminance is estimated based on the brightness of the dark region 152, etc., the estimation result of the illuminance may be lower than the actual illuminance. In other words the estimation accuracy of the illuminance may be reduced by the effect of the obstruction 150.

### Example Operation of Illuminance Estimation

As described above, if the illuminance is estimated based on the brightness of pixels in the bright or dark regions in the target image 300, the estimation accuracy of the illuminance may be reduced. In this embodiment, in the illumination control system 1, the controller 12 of the control device 10 estimates the illuminance based on the brightness of pixels of a grid that is positioned outside the bright and dark regions. An example operation of illuminance estimation of the controller 12 of the control device 10 according to this embodiment is described below.

### Format of Image Data

The controller 12 acquires a captured image from the image-capturing device 30. The captured image is assumed to be represented by data in a first format. The first format may be, but is not limited to, sRGB, for example.

The controller 12 may convert the data of the captured image to data of a second format that includes lightness as a parameter. The second format may be, for example, the CIE (Commission Internationale de l'Eclairage) 1976 L*a*b* color space. The CIE 1976 L*a*b* color space is one of the color spaces (complementary color spaces) used in various fields to represent the colors of objects. In the CIE 1976 L*a*b* color space, image data is represented using lightness L* and chromaticity a* and b* as parameters. The second format is not limited to the CIE 1976 L*a*b* color space described above, and may be various other formats.

The controller 12 may use the data of the captured image in the first format as is for the illuminance estimation, or may convert the data of the captured image to the second format for the illuminance estimation. The controller 12 may convert the data of the captured image to data of a third format that does not include lightness as a parameter and use the data of the third format for illuminance estimation. Hereafter, we assume that the controller 12 converts the data of the captured image into the data of CIE 1976 L*a*b* color space as the second format and uses this data for illuminance estimation.

### Setting Grids

The controller 12 sets grids on the target image 300. When the data of the captured image is expressed in a format including lightness as a parameter, the controller 12 estimates the illuminance based on the lightness of a pixel corresponding to a grid. When the data of the captured image is expressed in a format not including lightness as a parameter, the controller 12 estimates the illuminance based on the brightness of a pixel corresponding to a grid. An example of an operation in which controller 12 estimates illuminance based on the lightness of a pixel corresponding to a grid is described below.

A grid may be set to correspond to a single pixel or to a region containing multiple pixels. The controller 12 may set the grids to be equally spaced in the horizontal and vertical directions of the target image 300. The controller 12 may make the spacing of the grids in the horizontal direction the same as or different from the spacing of the grids in the vertical direction. The controller 12 may set the grids to be non-uniformly spaced in the horizontal direction or the vertical direction. The controller 12 may set the grids at the positions of lattice points, or may set the grid at positions offset from the lattice points. If the target image 300 is a distorted image formed by a fisheye lens or the like, the controller 12 may set the grids after correcting the distortion, or may set the grids without correcting the distortion.

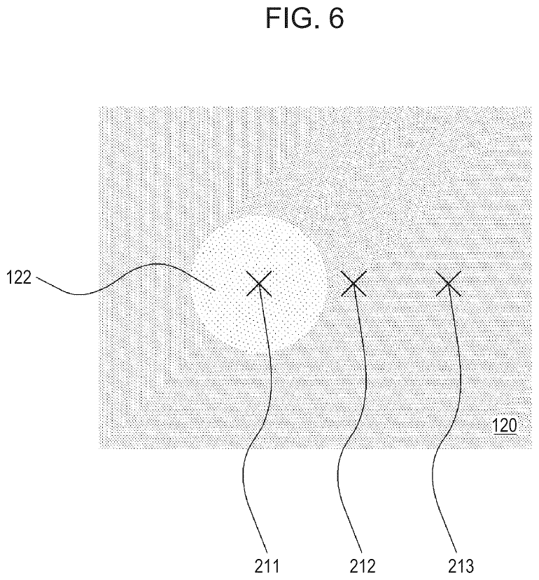

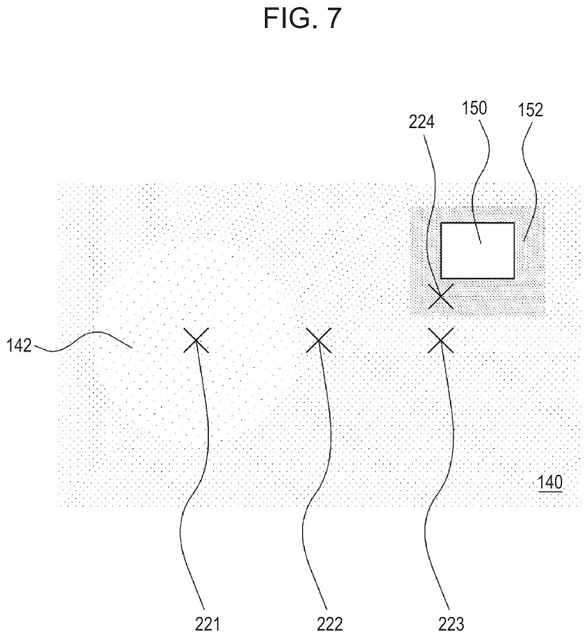

The controller 12 may set grids 211, 212, and 213 on pixels of the target image 300 where the floor 120 appears, as illustrated in FIG. 6. The grid 211 is positioned in the bright region 122. The grids 212 and 213 is positioned outside the bright region 122 of the floor 120. The controller 12 may set grids 221, 222, 223, and 224 on the pixels of the target image 300 where the desk 140 appears, as illustrated in FIG. 7. The grid 221 is positioned in the bright region 142. The grid 224 is positioned in the dark region 152. The grids 222 and 223 are positioned outside the bright region 142 and the dark region 152.

The controller 12 may estimate the illuminance at positions corresponding to the grids based on the lightness of the pixels at which each grid is set in the target image 300. When a grid corresponds to a single pixel, the controller 12 may estimate the illuminance based on the lightness of that single pixel. When a grid corresponds to a region containing multiple pixels, the controller 12 may estimate the illuminance based on various values, such as the average value, center value, median, maximum value, or minimum value of the lightnesses of the multiple pixels.

### Selecting Grid Used for Estimating Illuminance

As mentioned above, if the illuminance is estimated based on the lightness of a pixel of the grid 211 located in the bright region 122 or the grid 221 located in the bright region 142, the estimated value of the illuminance may be large. If the illuminance is estimated based on the lightness of a pixel of the grid 224 located in the dark region 152, the estimated value of illuminance may be small. The controller 12 may determine whether the grid is located in a bright region or a dark region and select a grid positioned outside of the light and dark regions as a grid for estimating the illuminance. An operation of selecting a grid in several different ways is described below.

### Selecting Grid Based on Color Tone

The controller 12 may select a grid by determining whether the grid is positioned in a bright region or a dark region based on a difference in the color tone of the image. The color tones of an image can be expressed as the chromaticity a* and b* in the CIE (Commission Internationale de l'Eclairage) 1976 L*a*b* color space, for example. The CIE 1976 L*a*b* color space is one of the color spaces (complementary color spaces) used in various fields to represent the colors of objects. In the CIE 1976 L*a*b* color space, image data is represented using lightness L* and chromaticity a* and b* as parameters. Hereafter, we will assume that the controller 12 can convert each pixel of the image data to the format of the CIE 1976 L*a*b* color space.

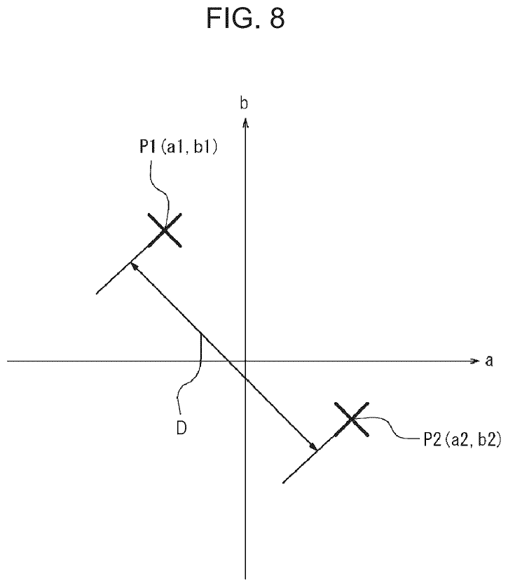

The controller 12 may calculate the chromaticity a* and b* of the pixels at two adjacent grids, express each chromaticity as a point on an a-b plane representing chromaticity as illustrated in FIG. 8, and calculate the difference between the chromaticities as the distance between the two points (Euclidean distance). The horizontal and vertical axes of the graph in FIG. 8 represent the values of a and b, respectively. For example, the chromaticity of the grid 211 located in the bright region 122 in FIG. 6 is represented as a point P1 (a1, b1) on the a-b plane. In addition, the chromaticity of the grid 212, which is positioned outside the bright region 122 in FIG. 6, is represented as a point P2 (a2, b2) on the a-b plane. The difference between the chromaticity of the grid 211 and the chromaticity of the grid 212 is calculated as the distance between the points P1 and P2. The distance between the points P1 and P2 is represented by D. Specifically, D is calculated using Equation (1) below.

[Math 1]

D=\sqrt{(a1-b1)²+(a2-b2)²} (1)

The controller 12 may determine that one of the two adjacent grids is positioned in a bright region or a dark region if the distance representing the difference in chromaticity between the pixels of the two adjacent grids is greater than or equal to a prescribed value. If the distance representing the difference in chromaticity between the pixels of the two adjacent grids is less than a distance threshold, the controller 12 may determine that the two adjacent grids are both positioned outside the bright regions and the dark regions. If the distance representing the difference in chromaticity between the pixels of the two adjacent grids is less than the distance threshold, the controller 12 may determine that the two adjacent grids are both positioned outside the bright regions or the dark regions. The distance threshold can be determined based on the tendencies of the color tones of captured images of the illumination control area 100, or spectral characteristics of the illumination light 40 or the outside light 50, etc., as appropriate.

The controller 12 may extract a combination of two adjacent grids from among the multiple grids set in the target image 300 and calculate the distance representing the difference in chromaticity for each combination. Usually, a bright region or a dark region is narrower than the other regions. Therefore, the controller 12 may determine that a region where there are many combinations for which the distance representing the difference in chromaticity is less than a prescribed value is a region that is outside the bright regions and dark regions. After determining grids that are positioned outside the bright regions and the dark regions, the controller 12 may determine that a grid is positioned in a bright region or a dark region if the distance representing the difference in chromaticity with respect to a grid determined to be located outside the bright regions and dark regions is greater than or equal to the distance threshold.

For example, in the target image 300 illustrated in FIG. 6, the controller 12 can determine that the distance representing the difference between the chromaticity of the grid 211 located in the bright region 122 and the chromaticity of the grid 212 located outside the bright region 122 is greater than or equal to the distance threshold. The controller 12 can also determine that the distance representing the difference between the chromaticity of the grid 212 and the chromaticity of the grid 213 located outside the bright region 122 is less than the distance threshold. Furthermore, the controller 12 can determine that the distance representing the difference between the chromaticity of the grid 213 and the chromaticity of another grid positioned adjacent to the grid 213 outside of the bright region 122 is less than the distance threshold.

The controller 12 may determine that there are many combinations for which the distance representing the difference in chromaticity is less than the distance threshold in the region where the grids 212 and 213 are positioned, and determine that the region where the grids 212 and 213 are positioned is a region that is outside the bright regions and the dark regions. On the other hand, the controller 12 may determine that the grid 211 is positioned in a bright region or a dark region based on the fact that the distance representing the difference between the chromaticity of the grid 211 and the chromaticity of the grid 212 is greater than or equal to the distance threshold.

For example, in the target image 300 illustrated in FIG. 7, the controller 12 can determine that the distance representing the difference between the chromaticity of the grid 221 located in the bright region 142 and the chromaticity of the grid 222 located outside the bright region 142 and the dark region 152 is greater than or equal to the distance threshold. The controller 12 can also determine that the distance representing the difference between the chromaticity of the grid 222 and the chromaticity of the grid 223 located outside the bright region 142 and the dark region 152 is less than the distance threshold. The controller 12 can also determine that the distance representing the difference between the chromaticity of the grid 223 and the chromaticity of the grid 224 located in the dark region 152 is greater than or equal to the distance threshold.

The controller 12 may determine that there are many combinations for which the distance representing the difference in chromaticity is less than the distance threshold in the region where the grids 222 and 223 are positioned, and determine that the region where the grids 222 and 223 are positioned is a region that is outside the bright regions and the dark regions. On the other hand, the controller 12 may determine that the grid 221 is positioned in a bright region or a dark region based on the fact that the distance representing the difference between the chromaticity of the grid 221 and the chromaticity of the grid 222 is greater than or equal to the distance threshold. In addition, the controller 12 may determine that the grid 224 is positioned in a bright region or a dark region based on the fact that the distance representing the difference between the chromaticity of the grid 223 and the chromaticity of the grid 224 is greater than or equal to the distance threshold.

The controller 12 may exclude grids determined to be positioned in the bright or dark regions from grids to be used for estimating the illuminance. The controller 12 may select a grid positioned outside the bright or dark regions as a grid to be used for estimating the illuminance. In the example in FIG. 6, the controller 12 may exclude the grid 211 from grids to be used for illuminance estimation and select the grid 212 or 213 as a grid to be used to estimate the illuminance. In the example in FIG. 7, the controller 12 may exclude the grids 221 and 224 from grids to be used for estimating the illuminance and select the grid 222 or 223 as a grid to be used for estimating the illuminance.

As described above, the controller 12 determines whether the distance representing the difference in color tone between two adjacent grids set in a captured image is less than a distance threshold. The controller 12 may set one of the two adjacent grids as a grid corresponding to a prescribed position in the illumination control area 100. The grid corresponding to the prescribed position in the illumination control area 100 is also referred to as a first grid. A grid set at a position adjacent to the first grid is also referred to as a second grid. The controller 12 may calculate color space coordinates representing the chromaticity of the pixel at which the first grid is set. The controller 12 may calculate color space coordinates representing the chromaticity of the pixel at which the second grid is set. The controller 12 may calculate the distance between the color space coordinates of the first grid and the color space coordinates of the second grid as a value representing the difference between the color tone of the first grid and the color tone of the second grid. The controller 12 may determine that the first grid is positioned outside the bright regions and the dark regions when the distance representing the difference between the color tone of the first grid and the color tone of the second grid is less than the distance threshold. The first grid being located outside the bright regions and dark regions can also be said to mean that the lightness or brightness of the first grid corresponds to the illuminance of the prescribed position.

### Selecting Grids Based On Comparison of Multiple Images

The controller 12 may acquire multiple captured images capturing a prescribed position in the illumination control area 100. The controller 12 may select an image to use for estimating the illuminance of the prescribed position based on a comparison of the lightness or brightness of the prescribed position appearing in each captured image.

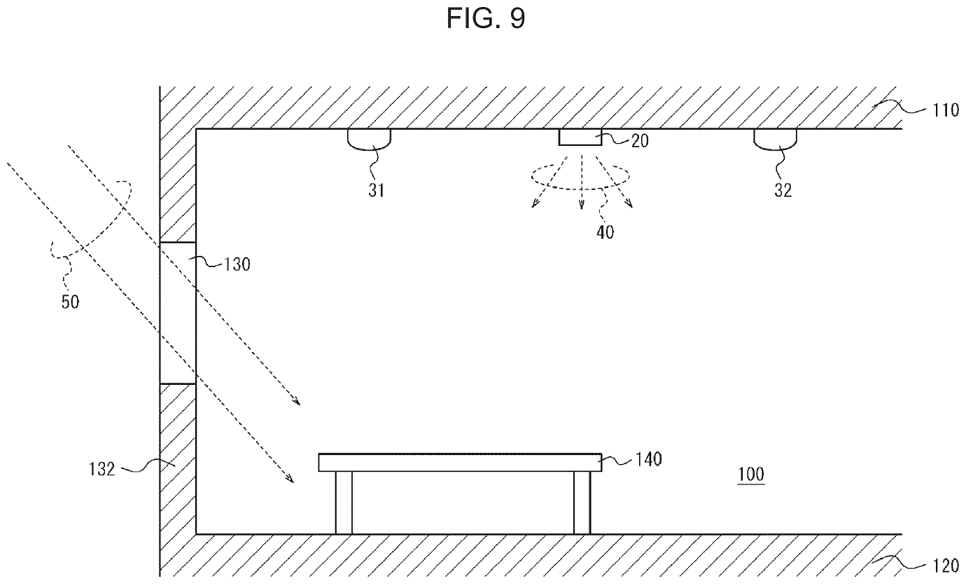

As illustrated in FIG. 9, the illumination control system 1 may include a first image-capturing device 31 and a second image-capturing device 32 installed in the illumination control area 100. In other words, multiple image-capturing devices 30 may be installed in the illumination control area 100. The first image-capturing device 31 is positioned closer to the window 130 than the second image-capturing device 32 is.

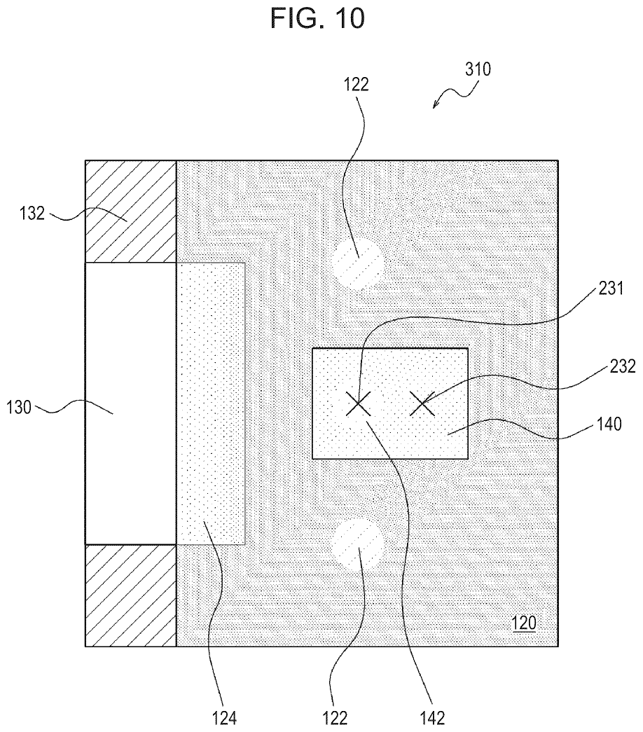

The controller 12 may acquire an image captured by the first image-capturing device 31 of a range including the desk 140 as a prescribed position in the illumination control area 100. As illustrated in FIG. 10, a target image 310 obtained by the first image-capturing device 31 capturing the illumination control area 100 includes a part in which the floor 120 appears, a part in which the desk 140 appears, and a part in which the window 130 and the wall 132 appears. The target image 310 includes the bright regions 122 that capture light resulting from the illumination light 40 being directly reflected by the floor 120. The target image 310 further includes the bright region 142 that captures light resulting from the illumination light 40 being directly reflected by the desk 140. The target image 310 further includes the bright region 124 that captures light resulting from the outside light 50 being directly reflected by the floor 120. The target image 310 is also referred to as a first captured image.

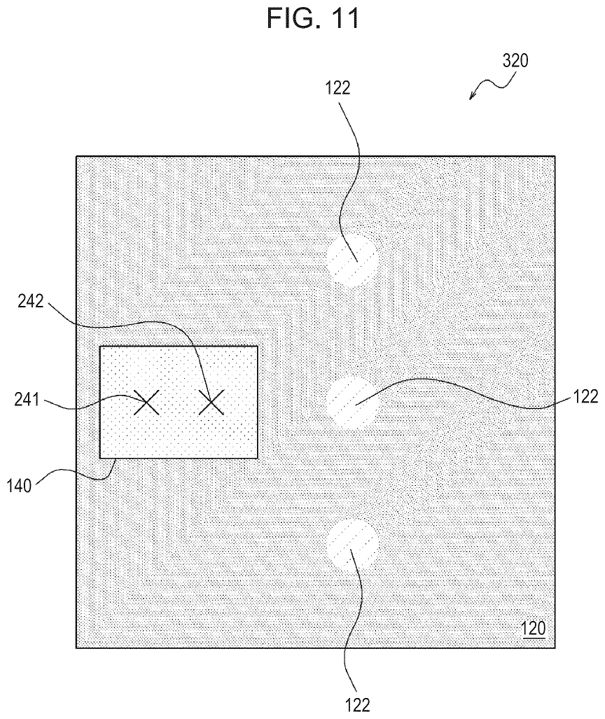

The controller 12 may acquire an image captured by the second image-capturing device 32 of a range including the desk 140 as a prescribed position in the illumination control area 100. As illustrated in FIG. 11, a target image 320 obtained by the second image-capturing device 32 capturing the illumination control area 100 includes a part in which the floor 120 appears and a part in which the desk 140 appears. The target image 320 includes the bright regions 122 that capture light resulting from the illumination light 40 being directly reflected by the floor 120. However, the light resulting from the illumination light 40 being directly reflected by the desk 140 does not appear in the target image 320. The target image 320 is also referred to as a second captured image.

The controller 12 may set a grid 231 in the part of the target image 310 in which the desk 140 appears in order to estimate the illuminance on the desk 140. The controller 12 may also set a grid 241 in the part of the target image 320 in which the desk 140 appears. The controller 12 sets the grid 231 and the grid 241 so the grids 231 and 241 correspond to the same position in the illumination control area 100. In other words, the controller 12 sets a grid on a part of the target images 310 and 320 that is common to both images.

The controller 12 compares the lightness of the grid 231 and the lightness of the grid 241. In the examples in FIG. 10 and FIG. 11, the lightness of the grid 231, which is located in the bright region 142, is higher than the lightness of the grid 241, which is located outside the bright region. The lightness of the part of the captured image in which directly reflected light, such as the illumination light 40 or outside light 50, appears in the image is higher than the lightness of the surrounding part in the image. Therefore, the controller 12 may estimate that directly reflected light appears at the grid 231. Conversely, the controller 12 may estimate that directly reflected light does not appear at the grid 241.

The lightness of a grid at which directly reflected light appears is affected not only by the illuminance of the area corresponding to that grid, but also by the directly reflected light. The proportion of the lightness of the grid that is contributed by the illuminance is reduced by effect of the directly reflected light. In other words, the lightness of the grid does not correspond to the illuminance. Consequently, the controller 12 may exclude the grid 231 from grids used to estimate the illuminance.

The controller 12 may select the grid 241, which was not excluded, as a grid to be used to estimate the illuminance. The controller 12 may further compare the lightness of the grid 241 with the lightness of a grid set in another captured image in which the part corresponding to the grid 241 commonly appears, and determine whether to select the grid 241 as a grid to be used for estimating the illuminance.

The controller 12 may set a grid 232 in the target image 310 and a grid 242 in the target image 320 as grids corresponding to a different part of the desk 140. The controller 12 compares the lightness of the grid 232 and the lightness of the grid 242. In the examples in FIG. 10 and FIG. 11, the grids 232 and 242 are both positioned outside of the bright regions. Therefore, the lightness of grid 232 and the lightness of grid 242 are identical or nearly identical. The controller 12 may select either of the grids 232 and 242 as the grid to be used for estimating the illuminance.

The controller 12 may set a grid in a part of each captured image that is common to three or more captured images. The controller 12 may compare the lightnesses of the grids set in the captured images and estimate that the grid with the lowest lightness is the grid that is least affected by directly reflected light. In other words, the controller 12 may estimate that the proportion of the lightness contributed by the illuminance is high at the grid with the lowest lightness. Therefore, the controller 12 may select the grid with the lowest lightness as a grid to be used for estimating the illuminance.

Conversely, among multiple captured images depicting the same position within the illumination control area 100, the lightness of pixels depicting that position may be lower in some of the captured images due to the effect of the obstruction 150. For example, the portion of a captured image in which a prescribed part is captured may appear as a dark region. On the other hand, in another captured image in which the prescribed part commonly appears, the portion in which the prescribed part is captured may appear as a region that is not a dark region. The controller 12 may compare the lightnesses of the grids set at corresponding positions in the captured images, and estimate that the grid with the highest lightness is the grid that is least affected by the obstruction 150. In other words, the controller 12 may estimate that the proportion of the lightness that is contributed by the illuminance is high at the grid with the highest lightness. Therefore, the controller 12 may select the grid with the highest lightness as the grid to be used for estimating the illuminance.

The controller 12 might not be able to easily determine whether the lightness of a pixel depicting the same position within the illumination control area 100 is high due to the effect of directly reflected light or low due to the effect of the obstruction 150 in some of the captured images among multiple captured images capturing the same position. The controller 12 may compare the lightnesses of grids set at corresponding positions in the captured images, and estimate that a grid that is close to the average lightness of the grids in the captured images is a grid that is less affected by directly reflected light and the obstruction 150. The controller 12 may estimate that a grid corresponding to the center value or median of the lightness among the grids set at corresponding positions in the captured images is the grid that is less affected by the directly reflected light and the obstruction 150. In other words, the controller 12 may estimate that the proportion of the lightness that is contributed by the illuminance is high at a grid where the lightness is neither high nor low. Therefore, the controller 12 may select, from among the grids set at corresponding positions in the captured images, a grid that is close to the average value of lightness or a grid corresponding to the center value or median of the lightnesses of the grids in the captured images, as a grid to be used for estimating the illuminance.

As described above, the controller 12 acquires multiple captured images in which a prescribed position in the illumination control area 100 is commonly captured. The controller 12 sets a grid in a part including the prescribed position in each of the captured images. The controller 12 may compare the lightnesses of the grids set in the captured images, and select a grid at which the proportion of the lightness contributed by the illuminance is high as the grid to be used for estimating the illuminance.

The controller 12 compares the lightnesses of the grids in the above example of operation, but the controller 12 may also compare the brightnesses of the grids. The controller 12 may select the grid where the proportion of the brightness contributed by the illuminance is high as a grid to be used for estimating illuminance. The controller 12 may select the grid with the highest brightness or the grid with the lowest brightness as the grid to be used for estimating the illuminance. The controller 12 may select the grid where the brightness corresponds to the average value, center value, or median of brightness as the grid to be used for estimating the illuminance. The controller 12 may estimate the illuminance based on the brightness of the selected grid.

The grid 231 corresponding to a prescribed position in the first captured image (target image 310) is also referred to as the first grid. The grid 241 corresponding to a prescribed position in the second captured image (target image 320) is also referred to as the second grid. The lightness of the first grid is also referred to as a first lightness. The lightness of the second grid is also referred to as a second lightness. The controller 12 may estimate that the first grid and the second grid are positioned outside of the bright regions and dark regions if the absolute value of the difference between the first lightness and the second lightness is less than a lightness threshold. In other words, when the absolute value of the difference between the first lightness and the second lightness is less than the lightness threshold, the controller 12 may determine that the lightnesses of the first grid and the second grid correspond to the illuminance of the prescribed position. The lightness threshold can be appropriately determined based on the overall lightness tendency of the captured images of the illumination control area 100, or the intensity or orientation of the illumination light 40 or the outside light 50, etc.

The controller 12 may use a brightness threshold instead of a lightness threshold when comparing brightnesses of the grids. The brightness threshold can be appropriately determined based on the overall brightness tendency of the captured images of the illumination control area 100, or the intensity or orientation of the illumination light 40 or the outside light 50, etc. The brightness of the first grid is also referred to as a first brightness. The brightness of the second grid is also referred to as a second brightness. In other words, when the absolute value of the difference between the first brightness and the second brightness is less than the brightness threshold, the controller 12 may determine that the brightnesses of the first grid and the second grid correspond to the illuminance of the prescribed position.

### Selecting Grids By Combining Comparison of Color Tones and Comparison of Multiple Images

The controller 12 may select grids to be used as comparison targets before comparing the lightnesses or brightnesses of grids set in portions that capture a prescribed position in multiple captured images, which all capture the prescribed position in the illumination control area 100. Specifically, the controller 12 may determine whether to use a grid set in a portion of each captured image capturing the prescribed position as a grid that is to be a comparison target based on a comparison of the color tone of the grid set in the portion capturing the prescribed position with the color tone of a grid adjacent to that grid. In other words, the controller 12 may determine whether to exclude a grid set in the portion capturing the prescribed position from the grids that are to be comparison targets. Hereafter, an example of an operation is described in which the controller 12 selects grids to be used as comparison targets for comparing grids set in multiple captured images based on a comparison of color tones, and selects grids to be used for estimating illuminance based on a comparison between the multiple captured images for the grids remaining after the selection.

The controller 12 calculates, for each of multiple captured images that all capture a prescribed position in the illumination control area 100, a distance that represents the difference between the color tone of a grid set in the portion capturing the prescribed position and the color tone of a grid that is adjacent to that grid. For grids for which the distance is greater than or equal to a prescribed value, the controller 12 estimates that the grid is located in a bright region or a dark region and excludes that grid from comparison targets to be compared with the grids in other captured images. For grids for which the distance is less than the prescribed value, the controller 12 estimates that the grid is located outside the bright regions and dark regions and retains that grid as a comparison target to be compared with the grids in the other captured images.

Among the grids set in a portion of each of the multiple captured images capturing the prescribed position in the illumination control area 100, when a grid that remains as a comparison target (a grid that was not excluded from the comparison targets through comparison of color tones) is present in two or more of the captured images, the controller 12 compares the lightnesses or brightnesses of the grid that remains as comparison target in the captured images. The controller 12 may select the grid with the lowest lightness or brightness and estimate the illuminance at the prescribed position in the illumination control area 100 based on the lightness or brightness of that grid. The controller 12 may select the grid with the highest lightness or brightness and estimate the illuminance at the prescribed position in the illumination control area 100 based on the lightness or brightness of that grid. The controller 12 may select the grid with the average value, center value or median of lightness or brightness and estimate the illuminance at the prescribed position in the illumination control area 100 based on the lightness or brightness of that grid.

When excluding grids based on a comparison of color tones, the controller 12 may estimate whether the excluded grids are grids located in a bright region or a dark region. If the controller 12 estimates that a grid that was excluded based on color tone comparison is a grid located in a dark region, the controller 12 may estimate that a grid in another captured image corresponding to the same position as that grid can also be excluded based on color tone comparison if the grid is located in a dark region. Therefore, the controller 12 may estimate that there is unlikely to be a grid located in a dark region among the grids remaining as comparison targets. As a result, the controller 12 may select the grid with the lowest lightness or brightness as a grid to use for estimating the illuminance in order to exclude grids located in or near the bright regions from the grids in the other captured images corresponding to the same position as that grid.

If the controller 12 estimates that a grid that was excluded based on color tone comparison is a grid located in a bright region, the controller 12 may estimate that a grid in another captured image corresponding to the same position as that grid can also be excluded based on color tone comparison if the grid is located in a bright region. Accordingly, the controller 12 may estimate that there is unlikely to be a grid located in a bright region among the grids remaining as comparison targets. As a result, the controller 12 may select the grid with the highest lightness or brightness as a grid to use for estimating the illuminance in order to exclude grids located in or near the dark regions from the grids in the other captured images corresponding to the same position as that grid.

If the controller 12 cannot estimate whether a grid excluded based on color tone comparison is a grid located in a bright region or a dark region, the controller 12 may estimate that there is a high probability that there is a grid located in a bright region or a dark region among the grids remaining as comparison targets. Therefore, the controller 12 may select a grid whose lightness or brightness is the average value, center value, or median of lightness or brightness as a grid for estimating the illuminance, in order to exclude grids located in or near bright regions and grids located in or near dark regions from the grids of other captured images corresponding to the same position as that grid.

### Summary of Example Operation of Grid Selection

As discussed above, the controller 12 can select a grid for estimating the illuminance so as to exclude grids located in bright or dark regions. When a grid is located outside the bright regions and dark regions, the proportion of the lightness or brightness of the pixel at which the grid is set that is contributed by the illuminance at the position corresponding to that grid to is greater than would be the case if the grid were located in a bright or dark region. Therefore, by excluding grids located in bright or dark regions, the controller 12 can select a grid where the proportion of the lightness or brightness of the pixel in the captured image that is contributed by the illuminance is high as a grid to use for estimating the illuminance. The statement that the proportion of the lightness or brightness of a pixel of a captured image capturing a prescribed position contributed by the illuminance of the prescribed position can be restated as the lightness or brightness of the captured image capturing a prescribed position corresponds to the illuminance at the prescribed position. In other words, when the lightness or brightness of an image capturing a prescribed position in the illumination control area 100 corresponds to the illuminance of the prescribed position, the controller 12 may estimate the illuminance of the prescribed position based on the lightness or brightness of the captured image. In this way, the effect of directly reflected light or the obstruction 150 on illuminance estimation can be reduced.

### Illuminance Estimation Based on Lightness or Brightness of Selected Grid

The controller 12 may estimate the illuminance of a portion of the illumination control area 100 corresponding to a grid, selected from among grids set in an image capturing the illumination control area 100, based on the lightness or brightness of that grid. For example, the controller 12 may determine the illuminance corresponding to the lightness or brightness as an estimated value from a table or a relational formula etc. representing the relationship between lightness or brightness and illuminance.

### Relationship Between Image-Capturing Conditions of Captured Image and Lightness or Brightness of Captured Image

The lightness or brightness of a captured image may vary depending on the image-capturing conditions at the time when the image-capturing device 30 captures the illumination control area 100. The image-capturing conditions of the image-capturing device 30 include shutter speed, aperture value, and ISO (international organization for standardization) sensitivity. For example, the faster the shutter speed, the shorter the time during which the image-capturing device 30 receives light using an image-capturing element. As a result, for the same amount of incident light, the higher the shutter speed, the lower the lightness or brightness of the captured image. The larger the aperture value, the smaller the amount of light incident on the image-capturing element. As a result, for the same amount of incident light, the larger the aperture value, the lower the lightness or brightness of the captured image. The higher the ISO sensitivity, the better the image-capturing element can detect even weak amounts of light. As a result, for the same amount of incident light, the higher the ISO sensitivity, the higher the lightness or brightness of the captured image.

When the image-capturing device 30 is a network camera, the aperture value and ISO sensitivity may be set to constant values. On the other hand, the shutter speed may be automatically adjusted in accordance with the brightness of a prescribed area such as the illumination control area 100. Here, let us assume that the aperture value and ISO sensitivity are set to constant values and the shutter speed is automatically adjusted in the image-capturing device 30. The brightness of the image captured by the image-capturing device 30 operating in this manner varies depending on the value of the shutter speed. Then, the relationship between the brightness of the captured image of the illumination control area 100 and the illuminance of the illumination control area 100 is determined in accordance with the value of the shutter speed. Therefore, the controller 12 needs to obtain the value of the shutter speed at the time when the image-capturing device 30 captured the image of the illumination control area 100 in order to estimate the illuminance based on the lightness or brightness of the captured image.

The aperture value or ISO sensitivity may also be adjusted automatically. In other words, image-capturing conditions may be automatically adjusted. In this case, the controller 12 needs to obtain the image-capturing conditions, including the shutter speed, the aperture value, or the ISO sensitivity, at the time when the image-capturing device 30 captured the image of the illumination control area 100 in order to estimate the illuminance based on the lightness or brightness of the captured image.

The controller 12 may acquire the image-capturing conditions from the image-capturing device 30. The controller 12 may estimate the image-capturing conditions based on the captured image. The controller 12 may estimate the illuminance of the illumination control area 100 based on the lightness or brightness of the captured image of the illumination control area 100 and the image-capturing conditions.

When the data of a captured image is converted to the second format, the controller 12 may correct the lightness of the image data by multiplying the lightness of the image data by a factor based on the image-capturing conditions. When the data of the captured image is represented by parameters that do not include lightness, the controller 12 may correct the brightness of the image data by multiplying the brightness of the image data by a factor based on the image-capturing conditions. The controller 12 may use a set value, a measured value, or an estimated value of the image-capturing conditions as a factor to multiply the lightness or brightness by in order to correct the lightness or brightness. For example, the controller 12 may correct the lightness or brightness by multiplying the lightness or brightness by the set value, measured value, or estimated value of the shutter speed.

### Control of Illumination Device 20

The controller 12 of the control device 10 may control the illumination devices 20 based on estimation results of the illuminance in each region of the illumination control area 100. For example, the controller 12 estimates the illuminance in a prescribed region illuminated by the illumination devices 20 disposed in the illumination control area 100. Based on the estimation results of illuminance of the prescribed region, the controller 12 controls the turning on or off of the illumination devices 20 illuminating the prescribed region or controls the intensity of the illumination light 40 emitted by the illumination devices 20 toward the prescribed region.

The controller 12 may control glare-free downlights as the illumination devices 20. As mentioned above, the glare-free downlights limit the effect of uncomfortable glare. Therefore, the extent to which the illumination light 40 emitted from the illumination devices 20 causes discomfort to people due to glare is limited. As a result, the comfort of people in the illumination control area 100 can be improved.

### Example Procedure of Estimation Method

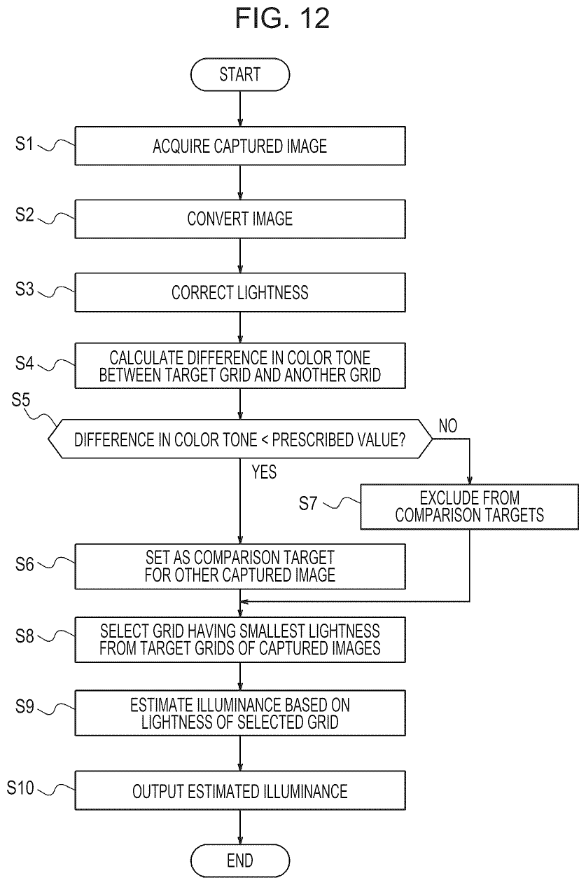

The controller 12 of the control device 10 may execute an illuminance estimation method and an illumination control method including the procedures of the flowchart illustrated in FIG. 12. The illuminance estimation method and the illumination control method may be realized as an illuminance estimation program and an illumination control program to be executed by a processor including the controller 12. The illuminance estimation program and the illumination control program may be stored on a non-transitory computer readable medium.

The controller 12 acquires a captured image from the image-capturing device 30 (Step S1). The controller 12 converts the format of the captured image from the first format to the second format (Step S2). The controller 12 corrects the lightness of the captured image based on image-capturing conditions (Step S3).

The controller 12 calculates a distance that represents the difference between the color tone of a target grid and the color tone of another other grid set in a part of the illumination control area 100 in which a prescribed position is captured (Step S4). The controller 12 determines whether the distance representing the difference in color tone is less than a prescribed value (Step S5).

When the distance representing the difference in color tone is less than the prescribed value (Step S5: YES), the controller 12 sets the target grid as a comparison target for a target grid in an image captured by another image-capturing device 30 (Step S6). When the distance representing the difference in color tone is not less than the prescribed value (Step S5: NO), that is, when the distance representing the difference in color tone is greater than or equal to the prescribed value, the controller 12 excludes the target grid from comparison targets (Step S7).

The controller 12 compares the lightnesses of the grids set as comparison targets (the grids remaining as comparison targets) among the girds in the images captured by the image-capturing devices 30 and selects the grid with the smallest lightness (Step S8). The controller 12 estimates the Illuminance of the prescribed position in the illumination control area 100 based on the lightness of the selected grid (Step S9). The controller 12 controls the illumination devices 20 that illuminate the prescribed position based on the illuminance estimation of the prescribed position in the illumination control area 100 (Step S10). After execution of the procedure of Step S10, the controller 12 completes execution of the procedures of the flowchart in FIG. 12.

In the above-described example procedures, the controller 12 selects a grid based on the difference in color tone within a single captured image, and then compares the lightnesses of the remaining grids between multiple captured images in order to select a grid to be used for estimating illuminance. The controller 12 is not limited to the above-described example procedures, and may compare the lightnesses between multiple captured images without selecting grids based on a difference in color tone, or may just select grids to be used for a difference in color tone. The controller 12 does not need to convert the format of a captured image. The controller 12 does not need to correct the lightness of a captured image. The controller 12 may select the grid with the highest lightness when comparing lightnesses between multiple captured images or may select the grid with the average, center value, or median lightness. The controller 12 may perform a procedure that combines the example operations described above with various contents or in various orders.

### Summary of Example Operation of Illuminance Estimation

As described above, in the illumination control system 1, the control device 10, and the illuminance estimation method performed by the control device 10 according to this embodiment, the illuminance is estimated based on the lightness or brightness when the lightness or brightness of the captured image corresponds to the illuminance of the illumination control area 100. In this way, the estimation accuracy of illuminance can be improved.

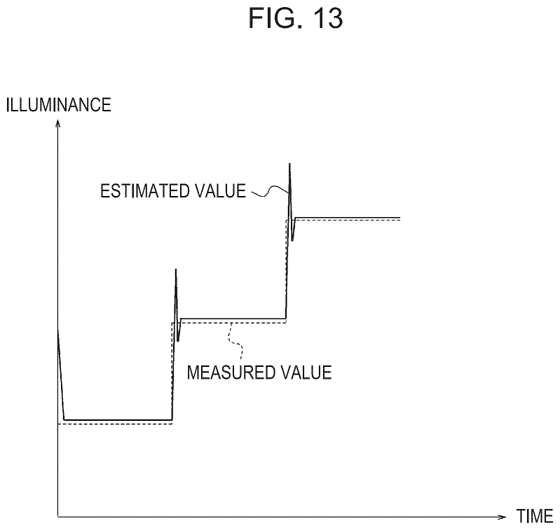

The graph in FIG. 13 illustrates an example of the relationship between the value of illuminance estimated by the controller 12 of the control device 10 according to this embodiment (estimated value) and the value of illuminance measured in the illumination control area 100 (measured value) by an illuminance sensor or another device. In the graph in FIG. 13, the horizontal axis represents time. The vertical axis represents the estimated value or the measured value of illuminance. The graph illustrated by a dashed line represents the measured values of illuminance. The graph illustrated by a solid line represents the estimated values of illuminance. The estimated values of illuminance overshoot or undershoot the measured values immediately after the illuminance (measured value) of the illumination control area 100 changes. However, the estimated value of illuminance follows the measured value during the period in which the illuminance (measured value) of the illumination control area 100 is stable. In other words, illuminance is estimated with high accuracy.

The control device 10 controls the illumination device 20 based on the estimation results of the illuminance of the illumination control area 100. In this way, the illuminance of the illumination control area 100 can be controlled with high accuracy.

### Other Embodiments

The illumination control system 1, the control device 10, the estimation method, or the illumination control method according to other embodiments will be described below.

### Separation of Components Contributing to Illuminance

The controller 12 of the control device 10 may separately estimate the illuminance in the illumination control area 100 for the illuminance contributed by the illumination light 40 and the illuminance contributed by the outside light 50. For example, the controller 12 may calculate the proportion of the lightness L* of the captured image that is contributed by the illumination light 40 and the proportion of the lightness L* of the captured image that is contributed by the outside light 50 based on the values of the chromaticity a* and b* of the captured image. The controller 12 may estimate the illuminance contributed by the illumination light 40 based on the lightness L* contributed by the illumination light 40, and the illuminance contributed by the outside light 50 based on the lightness L* contributed by the outside light 50. The controller 12 may calculate the estimated value of illuminance by weighting and summing the estimated values of illuminance contributed by each type of light.

The light that contributes to the illuminance of the illumination control area 100 is not limited to the illumination light 40 or the outside light 50, and may include a variety of other types of light.

The drawings illustrating the embodiments of the present disclosure are schematic drawings. The dimensional proportions and so on in the drawings do not necessarily match the actual dimensional proportions and so on.

A variety of variations and modifications may be made to the content of the present disclosure based on the present disclosure by one skilled in the art. Please note that, therefore, these variations or modifications are included within the scope of the present disclosure. For example, in each embodiment, each functional part, each means, each step and so on can be added to other embodiments so long as there are no logical inconsistencies, or can be replaced with each functional part, each means, each step, and so on of other embodiments. In each embodiment, a plurality of each functional part, each means, each step, and so on can be combined into a single functional part, means, or step or divided into multiple functional parts, means, or steps. Each of the above-described embodiments of the present disclosure is not limited to faithful implementation of each of the described embodiments, and may be implemented by combining or omitting some of the features as appropriate.

In the present disclosure, “first”, “second”, and so on are identifiers used to distinguish between such configurations. Regarding the configurations, “first”, “second”, and so on used to distinguish between the configurations in the present disclosure may be exchanged with each other. For example, identifiers “first” and “second” may be exchanged between the first grid and the second grid. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in this disclosure is not to be used as a basis for interpreting the order of such configurations or the existence of identifiers with smaller numbers.

In an embodiment, (1) an illuminance estimation method includes: acquiring a captured image of a range including a prescribed position captured by an image-capturing device; and when a lightness or brightness of the captured image corresponds to an illuminance of the prescribed position, estimating the illuminance of the prescribed position based on the lightness or brightness of the captured image.

(2) The illuminance estimation method of (1) above may further include: setting a first grid corresponding to the prescribed position and a second grid adjacent to the first grid in the captured image; calculating color space coordinates for each of the first grid and the second grid; and determining that a lightness or brightness of the first grid corresponds to the illuminance of the prescribed position when a distance between the color space coordinates of the first grid and the color space coordinates of the second grid is less than a distance threshold.

(3) The illuminance estimation method of (1) or (2) above may further include: acquiring multiple captured images of a range including the prescribed position captured by each of a plurality of the image-capturing device; calculating a lightness or brightness of a grid corresponding to the prescribed position in each of the multiple captured images for each of the multiple captured images; selecting the captured image for which the lightness or brightness of the grid corresponding to the prescribed position is lowest; and estimating the illuminance of the prescribed position based on the lightness or brightness of the grid corresponding to the prescribed position in the selected captured image.

(4) The illuminance estimation method of any one of (1) to (3) above may further include: acquiring a first captured image of a range including the prescribed position captured by a first image-capturing device as the image-capturing device; acquiring a second captured image of a range including the prescribed position captured by a second image-capturing device as the image-capturing device; calculating a lightness or brightness of a first grid corresponding to the prescribed position in the first captured image as a first lightness or a first brightness; calculating a lightness or brightness of a second grid corresponding to the prescribed position in the second captured image as a second lightness or a second brightness; and determining that the lightness or brightness of the first grid or the lightness or brightness of the second grid corresponds to the illuminance of the prescribed position when an absolute value of a difference between the first lightness or first brightness and the second lightness or second brightness is less than a lightness threshold or a brightness threshold.

In an embodiment, (5) an illumination control method may include: controlling an illumination device configured to illuminate a range including the prescribed position based on estimation of the illuminance of the prescribed position obtained by performing the illuminance estimation method according to any one of (1) to (4) above.

(6) The illumination control method of (5) above may include: controlling a glare-free downlight as the illumination device.

In an embodiment, (7) an estimation program is configured to cause a processor to: acquire a captured image of a range including a prescribed position captured by an image-capturing device; and when a lightness or brightness of the captured image corresponds to an illuminance of the prescribed position, estimate the illuminance of the prescribed position based on the lightness or brightness of the captured image.

In an embodiment, (8) a control device includes a controller configured to estimate an illuminance of a prescribed position. The controller is configured to acquire a captured image of a range including a prescribed position captured by an image-capturing device, and when a lightness or brightness of the captured image corresponds to an illuminance of the prescribed position, estimate the illuminance of the prescribed position based on the lightness or brightness of the captured image.

In an embodiment, (9) an illumination control system includes: a control device; an illumination device configured to illuminate a range including a prescribed position; and an image-capturing device configured to capture an image of the range including the prescribed position. The control device is configured to acquire a captured image of a range including the prescribed position captured by the image-capturing device, and when a lightness or brightness of the captured image corresponds to an illuminance of the prescribed position, estimate the illuminance of the prescribed position based on the lightness or brightness of the captured image.

1. An illuminance estimation method comprising:
acquiring a captured image of a range including a prescribed position captured by an image-capturing device; and
when a lightness or brightness of the captured image corresponds to an illuminance of the prescribed position, estimating the illuminance of the prescribed position based on the lightness or brightness of the captured image.

2. The illuminance estimation method according to claim 1, further comprising:
setting a first grid corresponding to the prescribed position and a second grid adjacent to the first grid in the captured image;
calculating color space coordinates for each of the first grid and the second grid; and
determining that a lightness or brightness of the first grid corresponds to the illuminance of the prescribed position when a distance between the color space coordinates of the first grid and the color space coordinates of the second grid is less than a distance threshold.

3. The illuminance estimation method according to claim 1 further comprising:
acquiring multiple captured images of a range including the prescribed position captured by each of a plurality of the image-capturing device;
calculating a lightness or brightness of a grid corresponding to the prescribed position in each of the multiple captured images for each of the multiple captured images;
selecting the captured image for which the lightness or brightness of the grid corresponding to the prescribed position is lowest; and
estimating the illuminance of the prescribed position based on the lightness or brightness of the grid corresponding to the prescribed position in the selected captured image.

4. The illuminance estimation method according to claim 1 further comprising:
acquiring a first captured image of a range including the prescribed position captured by a first image-capturing device as the image-capturing device;
acquiring a second captured image of a range including the prescribed position captured by a second image-capturing device as the image-capturing device;
calculating a lightness or brightness of a first grid corresponding to the prescribed position in the first captured image as a first lightness or a first brightness;
calculating a lightness or brightness of a second grid corresponding to the prescribed position in the second captured image as a second lightness or a second brightness; and
determining that the lightness or brightness of the first grid or the lightness or brightness of the second grid corresponds to the illuminance of the prescribed position when an absolute value of a difference between the first lightness or first brightness and the second lightness or second brightness is less than a lightness threshold or a brightness threshold.

5. An illumination control method comprising:
controlling an illumination device configured to illuminate a range including the prescribed position based on estimation of the illuminance of the prescribed position obtained by performing the illuminance estimation method according to claim 3.

6. The illumination control method according to claim 5, further comprising:
controlling a glare-free downlight as the illumination device.

7. A non-transitory computer readable medium storing an illuminance estimation program configured to cause a processor to:
acquire a captured image of a range including a prescribed position captured by an image-capturing device; and
when a lightness or brightness of the captured image corresponds to an illuminance of the prescribed position, estimate the illuminance of the prescribed position based on the lightness or brightness of the captured image.

8. A control device comprising:
a controller configured to estimate an illuminance of a prescribed position,
wherein the controller is configured to acquire a captured image of a range including a prescribed position captured by an image-capturing device, and
when a lightness or brightness of the captured image corresponds to the illuminance of the prescribed position, estimate the illuminance of the prescribed position based on the lightness or brightness of the captured image.

9. An illumination control system comprising:
the control device according to claim 8; an illumination device configured to illuminate a range including a prescribed position; and an image-capturing device configured to capture an image of the range including the prescribed position.
